(19) United States
(12) Patent Application Publication
(10) Pub. No.: US 2025/0024777 A1
(43) Pub. Date: Jan. 23, 2025

(54) SHIFTABLE MOW DECK

(71) Applicant: MTD PRODUCTS INC, Valley City, OH (US)

(72) Inventor: Adam Woodrum, Wakeman, OH (US)

(21) Appl. No.: 18/778,521

(22) Filed: Jul. 19, 2024

Related U.S. Application Data
(60) Provisional application No. 63/527,903, filed on Jul. 20, 2023.

(51) Int. Cl. A01D 34/66; A01D 34/00; A01D 101/00

(52) U.S. Cl. CPC A01D 34/661; A01D 34/008; A01D 2101/00

(57) ABSTRACT

Provided is a shiftable mowing deck, comprising a mow deck and a shift mount. A mow deck has a right side and a left side; a front and a back; a top and a bottom; and at least one blade set rotatably engaged with the bottom and adapted to be operated to mow. A shift mount is adapted to be operationally engaged between the mow deck and an associated mower, and to movably engage the mow deck to the associated mower. The shift mount has a fixed shift mount adapted to be fixed to an associated mower, and a movable shift mount fixed to the mow deck. The movable shift mount is adapted to move with respect to the fixed shift mount when mowing along a shift path and to move the mow deck with respect to the fixed shift mount along the shift path.

### CROSS-REFERENCE TO RELATED APPLICATION

This application claims the benefit of U.S. Provisional Application No. 63/527,903, filed Jul. 20, 2023, the entirety of which is hereby incorporated by reference.

### FIELD OF DISCLOSURE

The disclosed subject matter generally pertains to apparatuses for power equipment for outdoor maintenance applications. More specifically, the disclosed subject matter pertains to apparatuses for performing mowing operations related to a mower having one or more shiftable mow decks and for support of such mower components.

### BACKGROUND AND SUMMARY

Manufacturers of power equipment for outdoor maintenance applications (e.g., mowers) offer many types of machines for general maintenance and mowing applications. Generally, these machines can have a variety of forms depending on application, from general urban or suburban lawn maintenance, rural farm and field maintenance, to specialty applications. Even specialty applications can vary significantly.

Conventional fixed decks for mowers have a frame which fixes one or more mowing heads in both position and orientation with respect to the frame and to one another. This latter fixed arrangement creates a work area swept out by the blades that is fixed with respect to the mower and is moved with the mower to mow strips along a surface being mowed. During a mowing operation it is common to execute a turning maneuver on the surface being mowed to turn the mower to mow a strip adjacent to a previously mowed strip. During a turning maneuver of a mower with the latter referenced fixed work area, there is a portion of the work area that is moving redundantly because it is being moved over a portion of surface that has already been mowed. This redundant motion impugns efficiency.

Conventional fixed deck mowers also have a problem that it is difficult or impossible to properly mow areas under or near low branches, or near the perimeter of ponds, ditches, muddy areas, or impassible surfaces.

It remains desirable to address the inefficiency of redundant motion of mowers. Accordingly, it remains desirable to develop means and apparatuses to address this latter inefficiency. It also remains desirable to develop means and apparatuses to better mow areas near low branches, or near the perimeter of ponds, ditches, muddy areas, or impassible surfaces. The inventors have found that both of the latter issues may be addressed by providing latitude for the mow heads, or mow deck, to move with respect to the mower.

The following presents a simplified summary in order to provide a basic understanding of some aspects of the disclosure. This summary is not an extensive overview of the disclosure. It is not intended to identify key/critical elements or to delineate the scope of the disclosure. Its sole purpose is to present some concepts of the disclosure in a simplified form as a prelude to the more detailed description that is presented later.

Various embodiments of the present disclosure relate to a shiftable mowing deck, comprising a mow deck and a shift mount. A mow deck has a right side and a left side; a front and a back; a top and a bottom; and at least one blade set rotatably engaged with the bottom and adapted to be operated to mow. A shift mount is adapted to be operationally engaged between the mow deck and an associated mower, and to movably engage the mow deck to the associated mower. The shift mount has a fixed shift mount adapted to be fixed to an associated mower, and a movable shift mount fixed to the mow deck. The movable shift mount is adapted to move with respect to the fixed shift mount when mowing along a shift path and to move the mow deck with respect to the fixed shift mount along the shift path.

Further provided is a mower. The mower comprises a frame; a set of wheels operationally engaged with the frame and adapted to support the mower above a surface while moving over the surface during a mowing operation; a mow deck movably engaged with the frame, the mow deck having at least one blade set rotatably engaged with the mow deck and adapted to be operated to contribute to the mowing operation; a shift mount operationally engaged between the mow deck and the frame, the shift mount being adapted to movably engage the mow deck to the mower; and a power source adapted to supply sufficient energy to the shift mount to move the mow deck with respect to the frame along a shift path. The shift mount has a fixed shift mount component substantially fixed with respect to the frame, and a movable shift mount component substantially fixed with respect to the mow deck, the movable shift mount component adapted to be moved with respect to the fixed shift mount component during the mowing operation along a shift path and to move the mow deck with respect to the frame along the shift path.

Further provided is a method of conducting a mowing operation. The method comprises providing the aforementioned mower; operating the mower by moving it over a surface; using the blade to cut a mowable material; and moving the mow deck with respect to the frame along the shift path.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

FIG. 1 shows a perspective view of a schematic of a first embodiment of a mower having a shiftable mow deck apparatus.

FIG. 2 shows a perspective view of a box diagram of a frame.

FIG. 3 shows a perspective view of a box diagram of a mow deck.

FIG. 4 shows a close-up side view schematic of the shiftable mow deck apparatus from the first embodiment.

FIG. 5 shows a close-up front view schematic of the shiftable mow deck apparatus from the first embodiment.

FIG. 6 shows a schematic of a blade set from the first embodiment.

It should be noted that the drawings are diagrammatic and not drawn to scale. Relative dimensions and proportions of parts of the figures have been shown exaggerated or reduced in size for the sake of clarity and convenience in the drawings. The same reference numbers are generally used to refer to corresponding or similar features in the different embodiments, except where clear from context that same reference numbers refer to disparate features. Accordingly, the drawings and description are to be regarded as illustrative in nature and not as restrictive.

While embodiments of the disclosure pertaining to a shiftable mow deck are described herein, it should be understood that the disclosed apparatuses and methods are not so limited and modifications may be made without departing from the scope of the present disclosure. The scope of the systems, methods, and apparatuses are defined by the appended claims, and all devices, processes, and methods that come within the meaning of the claims, cither literally or by equivalence, are intended to be embraced therein.

### DETAILED DESCRIPTION

Various embodiments can comprise a shiftable mow deck apparatus according to various aspects discussed herein. As used herein, a shiftable mow deck apparatus may be referred to as part of an associated mower, but it is understood that the term “mower” is not limiting and that other powered equipment other than mowers for moving over and operating upon a surface are also contemplated. A shiftable mow deck apparatus can be engaged with an associated walk-behind mower or an associated ride-on mower of any of a variety of configurations, such as an associated seated mower, an associated standing mower, or an associated convertible seated/standing mower.

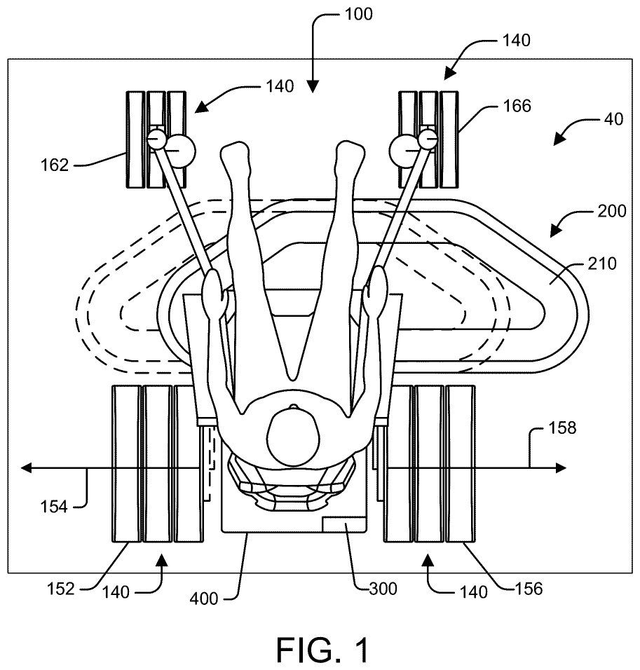

FIGS. 1-6 show a first non-limiting aspect of a shiftable mow deck apparatus 200 employable as or in connection with various embodiments of the present disclosure. With reference now to FIG. 1, shiftable mow deck apparatus 200 is shown engaged with a seated operator mower 100 providing a seat upon which the operator can control the mower 100. It should be understood, however, that this latter aspect is not limiting; in other acceptable aspects of the disclosed subject matter a shiftable mow deck apparatus 200 can be adapted for operational engagement with other associated mowers or associated power equipment such as one for a standing operator or for one convertible between standing/sitting configurations or for a walking operator, or for an associated robotic or automated mower.

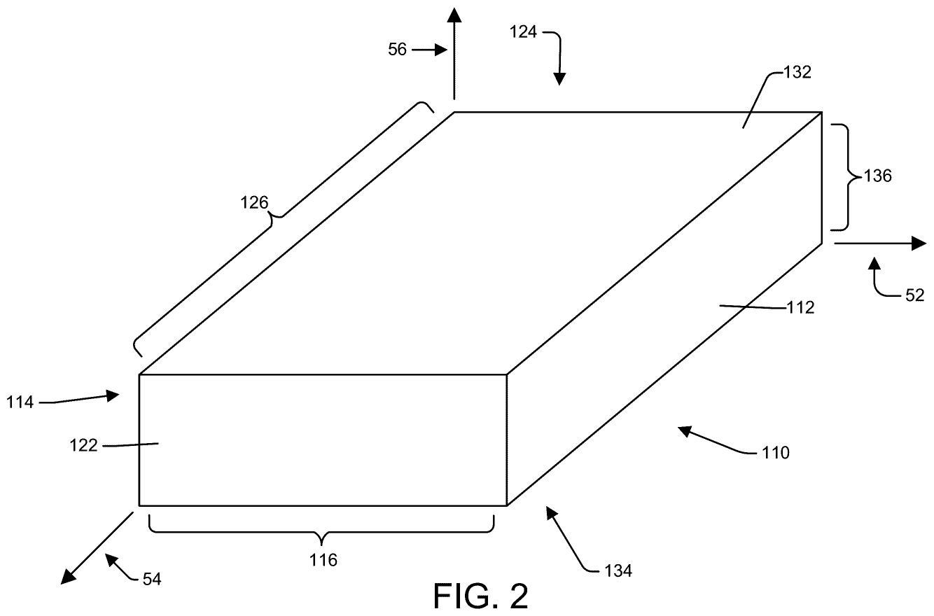

With continued reference to FIG. 1, and with further reference to FIGS. 2-5, shown is a mower 100 suitable for use in conjunction with a shiftable mow deck apparatus 200. A mower 100 comprises a frame 110, a set of wheels 140 operationally engaged with the frame 110, a mow deck 210 movably engaged with the frame 110, a shift mount 250 operationally engaged between the mow deck 210 and the mower 100 optionally at the frame 110 of the mower 100, and a power source 400.

As is conventional, the mower 100 is a device adapted for conducting a mowing operation over a surface 40. The mower 100 may be adapted to be moved over the surface 40 to sweep out a large area gradually mowed by the blade set of the mow deck 210.

The frame 110 may be any structure of sufficient integrity to substantially fix the components engaged therewith in operational engagement. Frame 110 may comprise tubing, structural angles, structural beams or other structural components chosen with good engineering judgment. Frame 110 may comprise steel alloy, aluminum alloy, magnesium alloy or other materials chosen with good engineering judgment. The frame 110 defines a frame right side 112 and a frame left side 114 opposite from the frame right side 112 and offset in a width direction 52 by a frame width 116. The frame 110 defines a frame front 122 and a frame back 124 opposite from the frame front 122 and offset in a depth direction 54 by a frame depth 126. The frame 110 defines a frame top 132 and a frame bottom 134 opposite from the frame top 132 and offset in a height direction 56 by a frame height 136.

The set of wheels 140 are adapted to support the mower 100 above the surface 40 while moving over the surface 40 during a mowing operation. In the non-limiting embodiment shown in FIG. 1, the set of wheels 140 comprises a first drive roller 152, a second drive roller 156, a first caster 162, and a second caster 166. The set of wheels 140 may be adjustable to permit selection of the height about the surface 40 at which the mowing operation is performed.

The first drive roller 152 may be adapted to rotate about a first drive axis 154 to apply work between the surface 40 and the mower 100 to promote motion of the mower 100 with respect to the surface 40. The second drive roller 156 may be adapted to rotate about a second drive axis 158 to apply work between the surface 40 and the mower 100 to promote motion of the mower 100 with respect to the surface 40. The first drive roller 152 and the second drive roller 156 may be controlled to each rotate at the same angular speed to promote motion of the mower 100 forward or in reverse or may be operated to turn at differing speeds to conduct a turning maneuver. In some turning maneuvers, the first drive roller 152 and the second drive roller 156 rotate at the same speed but in different directions to produce a “zero turn radius” turning maneuver. In some turning maneuvers, the first drive roller 152 and the second drive roller 156 rotate at differing speeds and in the same direction to produce a turning maneuver having a defined turn radius with the direction of the turn being toward the slower rotating drive roller.

As is typical of casters, each caster herein, e.g., first caster 162, and second caster 166, is a rotatable wheel mounted to rotate about a caster axis that is offset from a caster swivel axis by some caster lag distance such that, in operation, the caster will self-align to the direction of travel. In some embodiments, each caster swivel axis is substantially parallel to the height direction 56. Herein, substantially parallel means that the directions, or axes, or vectors in question are within an operationally trivial spatial range from parallel. Here it is to be understood that operationally trivial means that any deviation from the nominal orientation does not adversely affect the quality of operation in a way that is deemed important using good engineering judgment. In some aspects, that operationally trivial amount is no more than 4 mm or 4 degrees from the nominal parallel position and orientation. In some embodiments, one or more of the casters may be engaged to a system to actively steer the caster about the caster swivel axis.

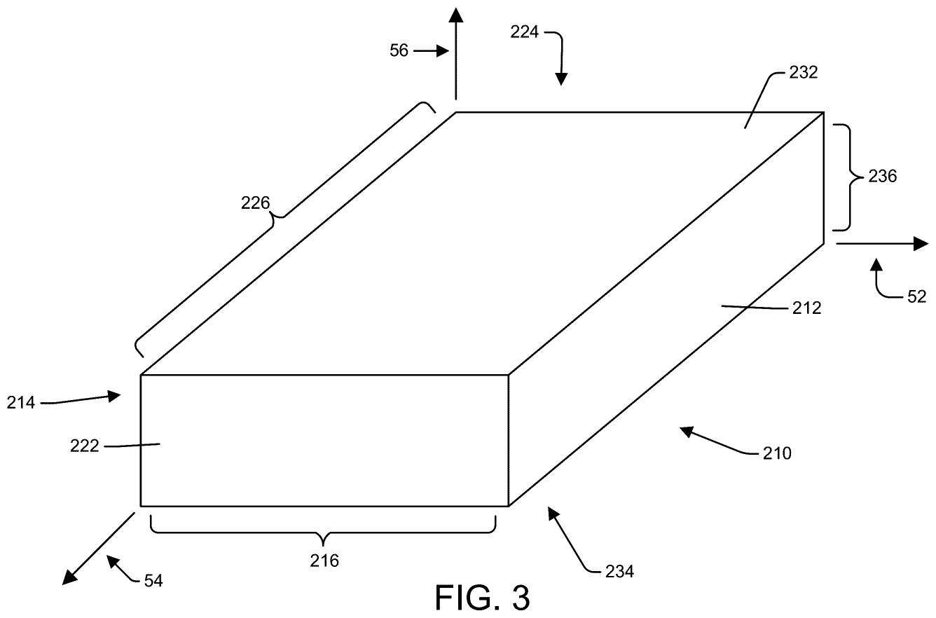

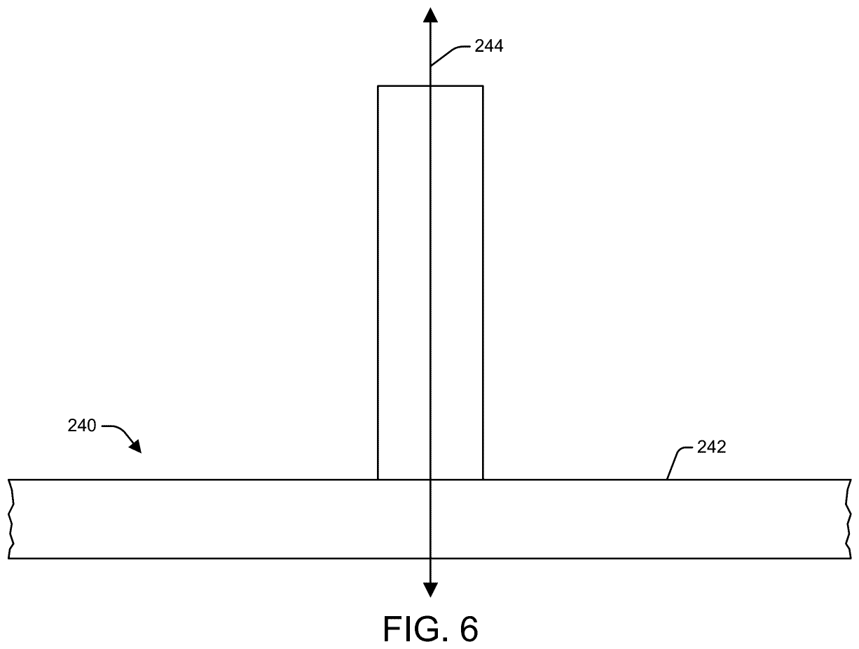

With reference now to FIGS. 2, 3 and 6 The mow deck 210 has a mow deck right side 212 and a mow deck left side 214 opposite from the mow deck right side 212 and offset in the width direction 52 by a mow deck width 216. The mow deck 210 has a mow deck front 222 and a mow deck back 224 opposite from the mow deck front 222 and offset in a depth direction 54 by a mow deck depth 226. The mow deck 210 has a mow deck top 232 and a mow deck bottom 234 opposite from the mow deck top 232 and offset in a height direction 56 by a mow deck height 236. The mow deck 210 has at least a first blade set 240 adapted to be operated to contribute to a mowing operation. In the non-limiting embodiment shown in FIGS. 3 and 6 first blade set 240 is rotatably engaged with the mow deck bottom 234. In some non-limiting embodiments, the at least one blade set 240 comprises at least a first blade 242 engaged with the mow deck 210 to operationally rotate about a first blade axis 244. In some embodiments, the mow deck 210 may comprise multiple blade sets each having at least one blade and each blade being engaged with the mow deck 210 to operationally rotate about a distinct blade axis. In some non-limiting embodiments, each blade axis is substantially parallel to the height direction 56 with blades rotatable thereabout to sweep out an operational plane normal to the height direction 56. In some alternative embodiments, a blade axis may be orientable to a direction substantially different from parallel to the height direction 56.

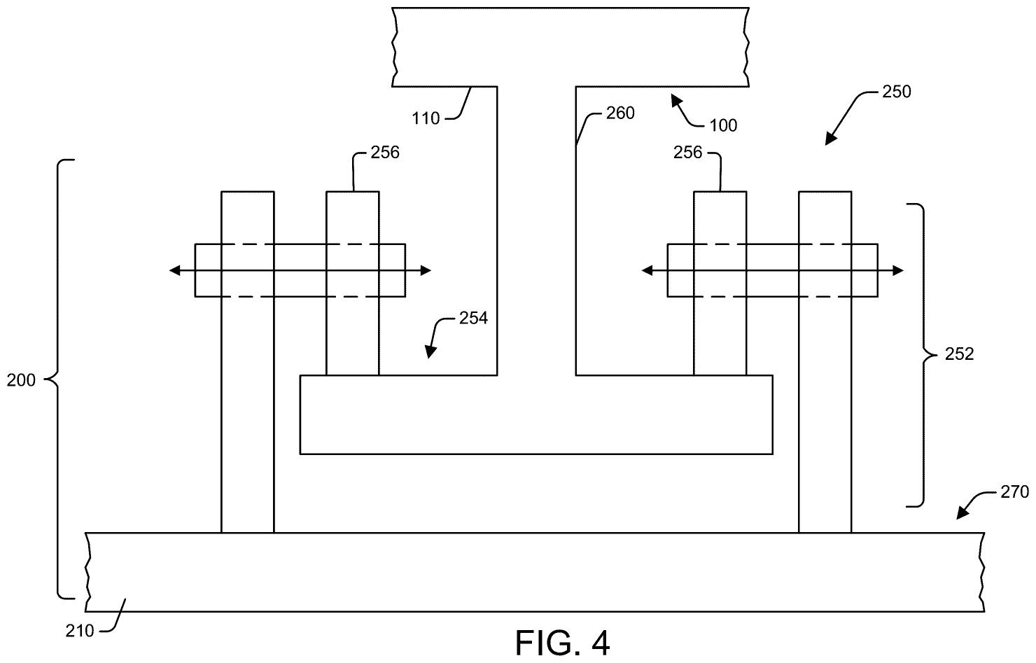

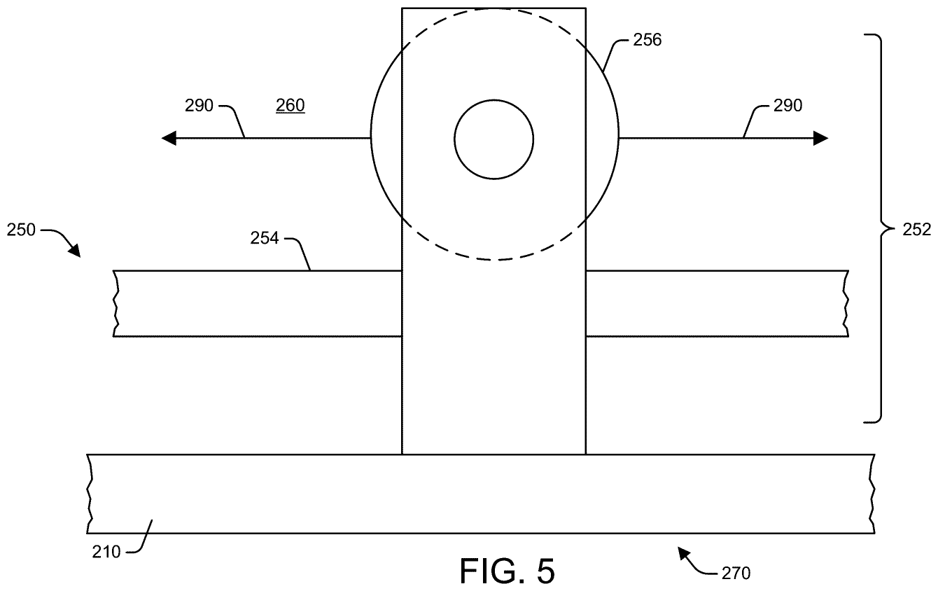

With reference now to FIGS. 4-5, the shift mount 250 movably engages the mow deck to the associated mower 100. The shift mount 250 comprises a fixed shift mount component 260 adapted to be substantially fixed with respect to an associated mower 100, and a movable shift mount component 270 substantially fixed with respect to the mow deck 100. The movable shift mount component 270 is adapted to be moved with respect to the fixed shift mount component 260 during the mowing operation along a shift path 290 and to move the mow deck 100 with respect to the fixed shift mount component 260 along the shift path 290.

The shift path 290 may be substantially linear or it may be curved. Herein, substantially linear means that the path in question is within an operationally trivial spatial range from a straight line. Here it is to be understood that operationally trivial means that any deviation from the nominal path does not adversely affect the quality of operation in a way that is deemed important using good engineering judgment. In some aspects, that operationally trivial amount is no more than 4 mm or 4 degrees from the nominal linear path.

In some non-limiting embodiments, the shift mount 250 comprises a mechanical linkage adapted to define shift path 290. In some non-limiting embodiments, the mechanical linkage may be a straight-line mechanism. Without limitation, some straight-line mechanisms that may be used include a Roberts linkage, a Peaucellier-Lipkin inversor, or a Watt's linkage. It should be understood that, while a Watt's linkage does not define a mathematically perfect straight line (as would a theoretical Peaucellier-Lipkin inversor) the path described by a Watt's linkage can be made substantially linear as defined above.

In some non-limiting embodiments, the shift mount 250 comprises a track and roller pair, or a shaft and linear bearing pair that defines the shift path 290. With continued reference to FIGS. 5-6, the non-limiting embodiment shown comprises a track and roller pair 252. While the track and roller pair 252 is shown with a straight track 254, it should be understood that the track 254 could be curved in other acceptable embodiments. In some optional embodiments, parts of the track and roller pair 252 may be shrouded to reduce or prevent contamination of the shrouded components with mowed materials, or dust, or debris.

In some non-limiting embodiments in which the shift path is curved, the curved path may define a plane normal to the height direction 56. In some non-limiting embodiments in which the shift path is substantially linear, it may be substantially parallel to the width direction 52.

With reference now to FIGS. 1, 4, and 5, in some optional embodiments, the mower 100 further comprises a control system 300. Control system 300 may be adapted to control motion of the mow deck 210 along the shift path 290. For example, in some non-limiting embodiments, the mow deck 210 may be moved along the shift path 290 by output from electrical motor. In embodiments in which there is a control system 300 adapted to control motion of the mow deck 210 along the shift path 290 the control system 300 may control the output from the electrical motor to define the position of the mow deck 210 along the shift path 290, the velocity of the mow deck 210 along the shift path 290, the acceleration of the mow deck 210 along the shift path 290, or some combination thereof. It should be understood that a control system 300 may comprise a digital computer or microprocessor and may control motion of the mow deck 210 along the shift path 290 in response to other operational parameters of the mower. Other operational parameters of the mower may include data supplied to the controller 300 from one or more transducers that may detect position of a steering control lever or wheel, orientation of first caster 162 about its caster swivel axis, orientation of second caster 166 about its caster swivel axis, mower position, mower velocity, mower acceleration, mower angular velocity about an axis parallel to the height direction 56, mower angular acceleration about an axis parallel to the height direction 56, mower angular velocity about an axis parallel to the depth direction 54, mower angular acceleration about an axis parallel to the depth direction 54, mower angular velocity about an axis parallel to the width direction 52, mower angular acceleration about an axis parallel to the width direction 52, or some combination thereof. For example, the control system 300 could initiate motion of the mow deck 210 along the shift path 290 when the mower 100 undergoes a turning maneuver. In some embodiment of the latter control, where the turning maneuver defines a turn direction, the control system could automatically initiate motion of the mow deck 210 along the shift path 290 away from the direction of the turn.

It is contemplated that automatically moving the mow deck along the shift path may be done automatically by the controller 300 to extend the radius being mowed during a turning maneuver. It is also contemplated that in embodiments wherein debris generated from mowing operations is discharged from the mow deck 210, (whether subsequently collected or not) the controller 300 may automatically move the mow deck along the shift path 290 to reorient the direction that debris is discharged from the mow deck 210 relative to the path of motion of the mower along the surface 40.

The power source 400 is a power source adapted to supply sufficient energy to the shift mount 250 to move the mow deck 210 with respect to the frame 110 along the shift path 290. The power source can be an electrical battery, an internal combustion engine, a flywheel, an external combustion engine, or otherwise as chosen with good engineering judgment. In embodiments in which the power source 400 is an electrical battery, the mower 100 may be an electric mower in which one or more powered elements, such as, and without limitation, first drive roller 152, second drive roller 156, first blade set 240, movable shift component 270, or some combination thereof, are moved by electric motors.

In addition to the apparatuses provided above, also provided is a first method of conducting a mowing operation. The method comprises providing a mower 100. The mower 100 has a frame 110, a set of wheels 140 operationally engaged with the frame 110 and adapted to support the mower 100 above a surface 40 while moving over the surface 40 during a mowing operation, a mow deck 210 movably engaged with the frame 110, the mow deck 210 having at least one blade set 240 rotatably engaged with the mow deck and adapted to be operated to contribute to the mowing operation, and a shift mount 250 operationally engaged between the mow deck 210 and the frame 110. The shift mount 250 is adapted to movably engage the mow deck 210 to the mower 100. The shift mount 250 has a fixed shift mount component 260 substantially fixed with respect to the frame 110 and a movable shift mount component 270 substantially fixed with respect to the mow deck 210. The movable shift mount component 270 is adapted to be moved with respect to the fixed shift mount component 260 during the mowing operation along a shift path 290 and to move the mow deck 210 with respect to the frame 110 along the shift path 290. The mower will further comprise a power source 400 adapted to supply sufficient energy to the shift mount 290 to move the mow deck 210 with respect to the frame 110 along the shift path 290. The method will further comprise operating the mower 100 by moving it over the surface 40, using the blade set 240 to cut a mowable material; and moving the mow deck 210 with respect to the frame 110 along the shift path 290. In some optional aspects of the latter first method, operating the mower 100 by moving it over the surface 40 further comprises conducting a turning maneuver defining a direction of a turn. In some optional aspects of the latter first method, moving the mow deck 210 with respect to the frame 110 along the shift path 290 further comprises, while conducting the turning maneuver, using a control system 300 to automatically move the mow deck 210 along the shift path 290 away from the direction of the turn.

In addition to the explicit disclosures above, it should be understood that the shiftable mow deck provided herein also provides functionally to mow areas difficult or impossible to mow with a conventional fixed deck mower. For example, and not limitation, the shiftable deck can mow areas under low branches, or around the perimeter of ponds, ditches, muddy areas, or impassible surfaces.

Generally, the illustrated embodiments are not provided as strict limitations on how the disclosed aspects can be practiced by one of ordinary skill in the art but are intended to be provided as examples that can be modified, interchanged, added to or subtracted from as would be suitable to one of ordinary skill in the art to accomplish the purposes and objectives described herein.

In regard to the various functions performed by the above described components, machines, devices, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments.

As utilized herein, relative terms and terms of degree including the term “about”, “approximately”, “substantially”, “roughly”, “near” and others are intended to incorporate ranges and variations about a qualified term reasonably encountered by one of ordinary skill in the art in fabricating, compiling or optimizing the embodiments disclosed herein to suit design preferences, where not explicitly specified otherwise. When utilized to modify a numerical description of a disclosed element, a relative term can imply a suitable range about the given number. Any implied range is intended to be consistent with and achieve the same or similar functions as described for the disclosed structure given the numerical description, where applicable. Where such ranges are not explicitly disclosed, a range within typical manufacturing tolerances associated with suitable manufacturing equipment (e.g., injection molding equipment, extrusion equipment, metal stamping equipment, and so forth) understood by one of ordinary skill in the art for realizing an element from a disclosed illustration or description can be implied. In some embodiments, depending on context and the capabilities of one of ordinary skill in the art, relative terminology can refer to a variation in a disclosed value or characteristic; e.g., a zero to two or three-percent variance, a zero to five-percent variance or a zero to ten-percent variance from precise mathematically defined value or characteristic, or any suitable value or range there between can define a scope for a disclosed term of degree. As an example, a disclosed mechanical dimension can have a variance of suitable manufacturing tolerances as would be understood by one of ordinary skill in the art, or a variance of a few percent about the disclosed mechanical dimension that would achieve a stated purpose or function of the disclosed mechanical dimension. Relative terms utilized for qualitative (rather than quantitative) description can be understood to imply explicitly stated alternatives or variations, variations understood in the art to occur from manufacturing tolerances or variations in a manufacturing process, variations understood in the art to achieve the function or purpose described for a particular component or process, or a suitable combination of the foregoing.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”, so that usage of “or” can have the same meaning as “and/or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. Moreover, embodiments described in a particular drawing or group of drawings should not be limited to those illustrations. Rather, any suitable combination or subset of elements from one drawing(s) can be applied to other embodiments in other drawings where suitable to one of ordinary skill in the art to accomplish objectives disclosed herein, known in the art, or reasonably conveyed to one of ordinary skill in the art by way of the context provided in this specification. Where utilized, block diagrams of the disclosed embodiments or flow charts are grouped for ease of understanding. However, it should be understood that combinations of blocks, additions of new blocks, re-arrangement of blocks, and the like are contemplated in alternative embodiments of the present disclosure.

Based on the foregoing it should be understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A shiftable mowing deck, comprising:
a mow deck having
a mow deck right side and a mow deck left side opposite from the mow deck right side and offset in a width direction by a mow deck width,
a mow deck front and a mow deck back opposite from the mow deck front and offset in a depth direction by a mow deck depth,
a mow deck top and a mow deck bottom opposite from the mow deck top and offset in a height direction by a mow deck height,
at least one blade set rotatably engaged with the mow deck bottom and adapted to be operated to contribute to a mowing operation;
a shift mount adapted to be operationally engaged between the mow deck and an associated mower, and to movably engage the mow deck to the associated mower, the shift mount having
a fixed shift mount component adapted to be substantially fixed with respect to an associated mower, and
a movable shift mount component substantially fixed with respect to the mow deck, the movable shift mount component adapted to be moved with respect to the fixed shift mount component during the mowing operation along a shift path and to move the mow deck with respect to the fixed shift mount component along the shift path.

2. The shiftable mowing deck of claim 1, wherein the shift path is substantially linear.

3. The shiftable mowing deck of claim 2, wherein the shift path is substantially perpendicular to the height direction.

4. The shiftable mowing deck of claim 2, wherein the shift path is substantially parallel to the width direction.

5. The shiftable mowing deck of claim 2, wherein the shift mount comprises a straight-line mechanism that defines the shift path.

6. The shiftable mowing deck of claim 5, wherein the straight-line mechanism comprises a Roberts linkage, a Peaucellier-Lipkin inversor, or a Watt's linkage.

7. The shiftable mowing deck of claim 1, wherein the shift mount comprises a track and roller pair, or a shaft and linear bearing pair that defines the shift path.

8. The shiftable mowing deck of claim 4, wherein the shift mount comprises a straight-line mechanism.

9. The shiftable mowing deck of claim 8, wherein the straight-line mechanism comprises a Roberts linkage, a Peaucellier-Lipkin inversor, or a Watt's linkage.

10. The shiftable mowing deck of claim 4, wherein the shift mount comprises a track and roller pair, or a shaft and linear bearing pair that defines the shift path.

11. A mower, comprising:
a frame defining
a frame right side and a frame left side opposite from the frame right side and offset in a width direction by a frame width,
a frame front and a frame back opposite from the frame front and offset in a depth direction by a frame depth,
a frame top and a frame bottom opposite from the frame top and offset in a height direction by a frame height;
a set of wheels operationally engaged with the frame and adapted to support the mower above a surface while moving over the surface during a mowing operation;
a mow deck movably engaged with the frame, the mow deck having at least one blade set rotatably engaged with the mow deck and adapted to be operated to contribute to the mowing operation;
a shift mount operationally engaged between the mow deck and the frame, the shift mount being adapted to movably engage the mow deck to the mower, the shift mount having
a fixed shift mount component substantially fixed with respect to the frame, and a movable shift mount component substantially fixed with respect to the mow deck, the movable shift mount component adapted to be moved with respect to the fixed shift mount component during the mowing operation along a shift path and to move the mow deck with respect to the frame along the shift path; and
a power source adapted to supply sufficient energy to the shift mount to move the mow deck with respect to the frame along the shift path.

12. The mower of claim 11, wherein the shift path is substantially linear.

13. The mower of claim 12, wherein the shift path is substantially parallel to the width direction.

14. The mower of claim 13, wherein the shift mount comprises a straight-line mechanism, a track and roller pair, or a shaft and linear bearing pair.

15. The mower of claim 14, wherein the power source is an electric battery.

16. The mower of claim 15, further comprising a control system adapted to control motion of the mow deck along the shift path.

17. The mower of claim 15, wherein the control system is an automated control which initiates motion of the mow deck along the shift path when the mower is turned.

18. A method of conducting a mowing operation comprising:
providing a mower having
a frame defining
a frame right side and a frame left side opposite from the frame right side and offset in a width direction by a frame width,
a frame front and a frame back opposite from the frame front and offset in a depth direction by a frame depth,
a frame top and a frame bottom opposite from the frame top and offset in a height direction by a frame height,
a set of wheels operationally engaged with the frame and adapted to support the mower above a surface while moving over the surface during a mowing operation,
a mow deck movably engaged with the frame, the mow deck having at least one blade set rotatably engaged with the mow deck and adapted to be operated to contribute to the mowing operation,
a shift mount operationally engaged between the mow deck and the frame, the shift mount being adapted to movably engage the mow deck to the mower, the shift mount having
a fixed shift mount component substantially fixed with respect to the frame, and
a movable shift mount component substantially fixed with respect to the mow deck, the movable shift mount component adapted to be moved with respect to the fixed shift mount component during the mowing operation along a shift path and to move the mow deck with respect to the frame along the shift path, and
a power source adapted to supply sufficient energy to the shift mount to move the mow deck with respect to the frame along the shift path; and
operating the mower by moving it over a surface;
using the blade to cut a mowable material; and
moving the mow deck with respect to the frame along the shift path.

19. The method of conducting a mowing operation of claim 18, wherein operating the mower by moving it over a surface further comprises conducting a turning maneuver defining a direction of a turn.

20. The method of conducting a mowing operation of claim 19, wherein moving the mow deck with respect to the frame along the shift path further comprises, while conducting the turning maneuver, using a control system to automatically move the mow deck along the shift path away from the direction of the turn.
